(19) United States
(12) Patent Application Publication
(10) Pub. No.: US 2007/0283780 A1
(43) Pub. Date: Dec. 13, 2007

(54) Automated Device and Method for Manufacturing a Door

(76) Inventors: Ed Smock, Moberly, MO (US); Don Nelson, Moberly, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/743,628

(22) Filed: May 2, 2007

Related U.S. Application Data
(60) Provisional application No. 60/746,233, filed on May 2, 2006.

(51) Int. Cl. B25J 18/00; B25J 15/06

(52) U.S. Cl. 74/490.01; 901/2

(57) ABSTRACT

An automated device for manufacturing doors is provided that includes a robot, a conveyor for removing cutouts for disposal, a router station, and door stacks within a cell surrounded by a cage. A touch-screen controller allows a user to enter door orders and controls the robot and tooling located on the end of the robot to select doors from the stacks, place them on the router table and cut the door pursuant to the order and move the completed door to appropriate location for delivery.

### CROSS-REFERENCE TO RELATED APPLICATIONS

This application claims priority pursuant to 35 U.S.C. 119(e) to copending U.S. Provisional Patent Application Ser. No. 60/746,233, filed May 2, 2006, the entire disclosure of which is incorporated herein by reference.

### DETAILED DESCRIPTION OF THE INVENTION

The present invention eliminates various disadvantages of previous devices and methods for the manufacture of doors, including eliminating the added work space requirements that come from having multiple workstations, cycle time restrictions resulting from changing tools or templates, door damage due to handling of the door during the manufacturing process, added inventory skews needed to cover opens, difficulties in creating double bores, peep sites, mail slots, and the like, ergonomic issues associated with the manufacturing process, and pulling doors for processing. Other disadvantages of existing devices and methods will also be apparent upon reading the disclosure below.

One advantage of the present device and method for manufacturing doors is an increase in cycle time. All bores, cutouts, and mortises are performed at a single station, utilizing the same drill bit, and are performed in a matter of seconds rather than minutes. Tool changing is not required as each cutting procedure performed on the door is done with the same device.

The present invention also simplifies the pulling of doors for processing according to the needs of a manufacturer. Doors are preferably positioned within reach of the robotic arm of the present device on the original skid used by the supplier. In some cases, such as in the case of special doors, they may have to be manually stacked for use by the present device. In either case, production time for the manufacture of the doors is reduced dramatically.

The present device also results in cost savings as compared with prior methods of door production because the number of workers needed during the manufacturing process is reduced. A single operator is able to enter door orders on an interactive touch-screen connected to a computer that holds all door lengths, widths, types, lite types, information on single, double, triple, or fire bores, and other information pertinent to the specific type of door being manufactured.

The present invention also results in a simplified, more efficient, and more cost-effective inventory. Due to the speed at which the device operates, inventory skews can be reduced or eliminated entirely, and depending on the market demands, opens may also be reduced or eliminated.

With respect to ergonomic factors, safety-related injuries are reduced or eliminated due to the substantial reduction in the need for workers to handle the door before, during, and after the manufacturing process.

The present device also reduces manufacturing process-related door damage due to less frequent handling of the doors by workers. During one period in which the present device was tested, door damage rates went from five to ten damaged doors per day to one to two damaged doors per day, with a portion of the one to two damaged doors per day being due to operator error and not due to the present device.

The present invention provides a simple touch-screen method for entering information specific to the type of door being manufactured, and also for starting and controlling the present device, indicating the type and number of doors to be produced, and the like. This simplified system allows for a reduction in training time for new employees and also cuts down on operator error by providing an intuitive, easy to understand interface.

The cell layout used in conjunction with the present device is variable according to the needs of the user. For example, a cell design may include five carts for doors, or may be modified to include a greater or lesser number of carts. Further, the location of carts with respect to the device may also be modified according to a user's needs. The present device may also be programmed, via the touch-screen, to treat differently doors located in various carts. For example, out of a five cart layout, four carts may be provided with the door type most commonly produced and therefore needed in greater numbers, while the fifth cart may hold doors for nonstandard or custom production. Should the applicable market change, a user need only use the touch-screen to change the cart designation and begin producing new doors in accordance with market demands.

Further advantages of the present device and method include the fact that the present device drills peep sites in a single motion, without having to flip the door and risk damage to the door, the completed doors are automatically ejected to the lite table, and that cutouts are automatically conveyed to a hopper for disposal thereof. A collection system provided with the present device removes loose material.

The present device and method also provide a high level of precision, due to the computer-controlled, automated aspect of the invention. Further, the present system is highly customizable and may be modified to suit changing market demands.

The following provides an exemplary process utilizing the present device and method. It is contemplated that the details below may be modified or customized according to the needs of an end-user without departing from the scope of the present invention.

In an exemplary process utilizing the present invention, five carts are positioned around the robotic arm of the present device, four of the carts provided for high-volume doors and a fifth provided for custom doors. Each cart is preferably capable of holding at least twenty-seven 1.75″ thick doors, although the dimensions of each cart may be varied according to the needs of an particular user.

Initially, the carts are rolled out of the cells provided with the present system and doors are loaded thereon via forklift or other accepted method. Preferably, the doors remain on the original pallet provided by the supplier. The carts, upon which the pallets and doors now rest, are rolled into the appropriate cells and locked in place to ensure proper positioning of the doors for use by the present device. A user then enters the required door orders on a touch-screen that contains the specifics of all door orders that have been programmed into the present device. The touch-screen will preferably accept an order of at least ninety-nine doors, though it is contemplated that the number of doors that can be ordered using the present device may vary according to the needs of a user. The touch-screen includes or is connected to a computer processor that includes software and/or firmware to control the robotic arm, router, conveyor and any other components of the device of the instant invention in accordance with the operational methods described herein.

Once the door orders have been properly entered via the touch-screen, the user starts the process, either by pressing a start button or by other suitable methods, and the robotic arm positions itself to pick up the first door. It is preferred that the robotic arm pick up the door by use of a vacuum or suction created by the device, thereby picking up the door without doing damage to the surface of the door. Once the robotic arm has secured the door, the door is transferred to the router station.

At the router station, the door is preferably clamped by automated means, and in such as way as to not damage the surface of the door, and the end of the robotic arm swivels such that a router is positioned in a downward direction rather than the suction portion used to pick up and transfer the door. The robotic arm then performs all cuts, mortises, and bores with a single router bit. After this process is completed, the end of the robotic arm swivels once more, returning to the suction portion used to pick up and transfer doors, and transfers the cut door to the appropriate location for finished doors.

Once a door is completed, the present device will automatically proceed to the next door, repeating the procedure above, until it reaches the last door in the programmed sequence. The process may, however, be interrupted prior to normal completion. If, for example, a rush order comes in to the manufacturing facility, a user may press a stop button or otherwise instruct the present device to discontinue its current program. If the device is in the middle of producing a door, it will preferably continue with that door until finished, and then stop. The user may then enter the new information pertinent to the rush order and once again start the process. The present device will then begin manufacturing door in accordance with the requirements of the rush order.

The foregoing provides an exemplary method and device constructed in accordance with the teachings of the present invention. It is contemplated that various modifications and additions may be made to the device or method without departing from the spirit and scope of the present invention. Such modifications and additions will be readily apparent to those of skill in the art upon reading this disclosure. The customizability and programmability of the present device results in a device and method that is virtually limitless in application.

### DESCRIPTION OF THE DRAWINGS

FIG. 1 is an exemplary embodiment of a cell layout of the instant invention including robot 10, conveyor 20 for removing cutouts for appropriate disposal, router station 30, and door stacks 40 all surrounded by cage 60 and touch-screen controller 50 connected to and capable of controlling the above-described components.

FIG. 2 is a detailed view of robot 10 showing the robot end of the arm tooling including router 12, vacuum cups 14, and dress out unit 16.

FIG. 3 is a detailed view of touch-screen 50 illustrating an embodiment of an entry level menu that includes the following options: orders menu; stack overview; chip conveyor controls; system mode selection; manual controls; cell setup menu; monitor I/O menu; and fault diagnostics.

FIG. 4 is a detailed view of touch-screen 50 illustrating an embodiment of the “orders menu” option in which a user is provided options to enter new orders, review existing orders (and put existing orders on hold if so desired), and cancel all or some existing orders.

FIG. 5 is a detailed view of touch-screen 50 illustrating an embodiment of a review orders menu.

FIG. 6 is a detailed view of touch-screen 50 illustrating an embodiment of a main production screen from which a user selects the desired mode of operation (manual or automatic), locks/unlocks gates to cage 60, and starts/stops the cycle sequence. Also shown in FIG. 6 are two “quick” buttons to allow the user to go directly to the order entry or order review screens.

FIG. 7 is a detailed view of touch-screen 50 illustrating an embodiment of a stacks overview screen in which the user of the instant invention may review and/or store in the processor the door style that is located in each stack within the cell shown in FIG. 1. As is shown in FIG. 7 pictorial representations of robot 10, router station 30 and door stacks 40 are shown on the touch-screen to aid the user in storing the appropriate door style with each stack.

FIG. 8 is a detailed view of touch-screen 50 illustrating chip conveyor 20 on and off controls.

FIG. 9 is a detailed view of touch-screen 50 illustrating an embodiment of a manual operation menu including further options to control the clamp/router table 30, the router on robot 10 and a manual program sequence.

FIG. 10 is a detailed view of touch-screen 50 illustrating an embodiment of clamp/router table controls when selected from the menu shown in FIG. 9.

FIG. 11 is a detailed view of touch-screen 50 illustrating an embodiment of manual router controls when selected from the menu shown in FIG. 9.

FIG. 12 is a detailed view of touch-screen 50 illustrating door sizes/types that are programmed into the processor and which may be selected by the user when operating in manual control mode.

FIGS. 13a and 13b show a cell setup main menu and security code entry screen displayed on touch-screen 50 of an embodiment of the invention when a user attempts to setup properties of the cell. The cell setup menu includes options for the user to input door properties, stack properties, PLC parameters and to setup the cutout program.

FIG. 14 is a detailed view of touch-screen 50 illustrating an entry level diagnostic screen that shows inputs/outputs necessary for a user to troubleshoot problems if a communication issue arises between the processor and the controlled components of the device of the instant invention (i.e. robot, clamp table, conveyor, etc.).

FIG. 15 is a detailed view of touch-screen 50 illustrating an embodiment of a PLC inputs screen chosen from options shown in the diagnostic screen of FIG. 14.

FIG. 16 is a detailed view of touch-screen 50 illustrating an embodiment of a PLC outputs screen chosen from options shown in the diagnostic screen of FIG. 14.

FIG. 17 is a detailed view of touch-screen 50 illustrating an embodiment of a robot I/O signals monitoring screen chosen from options shown in the diagnostic screen of FIG. 14.

FIG. 18 is a detailed view of touch-screen 50 that allows a user to reset faults to occur during operation to allow the device of the instant invention to continue operation and/or allows a user to review fault history stored in the processor.

FIG. 19 is a detailed view of touch-screen 50 illustrating a fault history/reset screen.

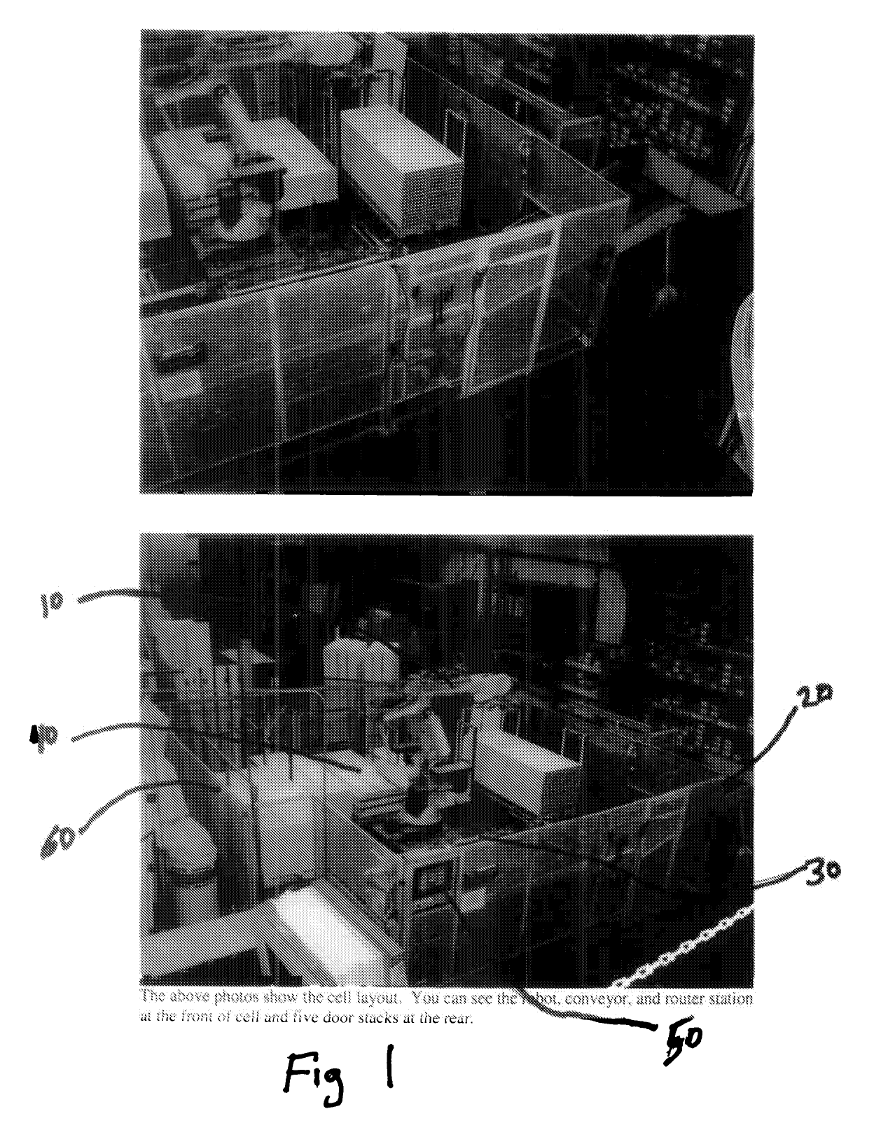

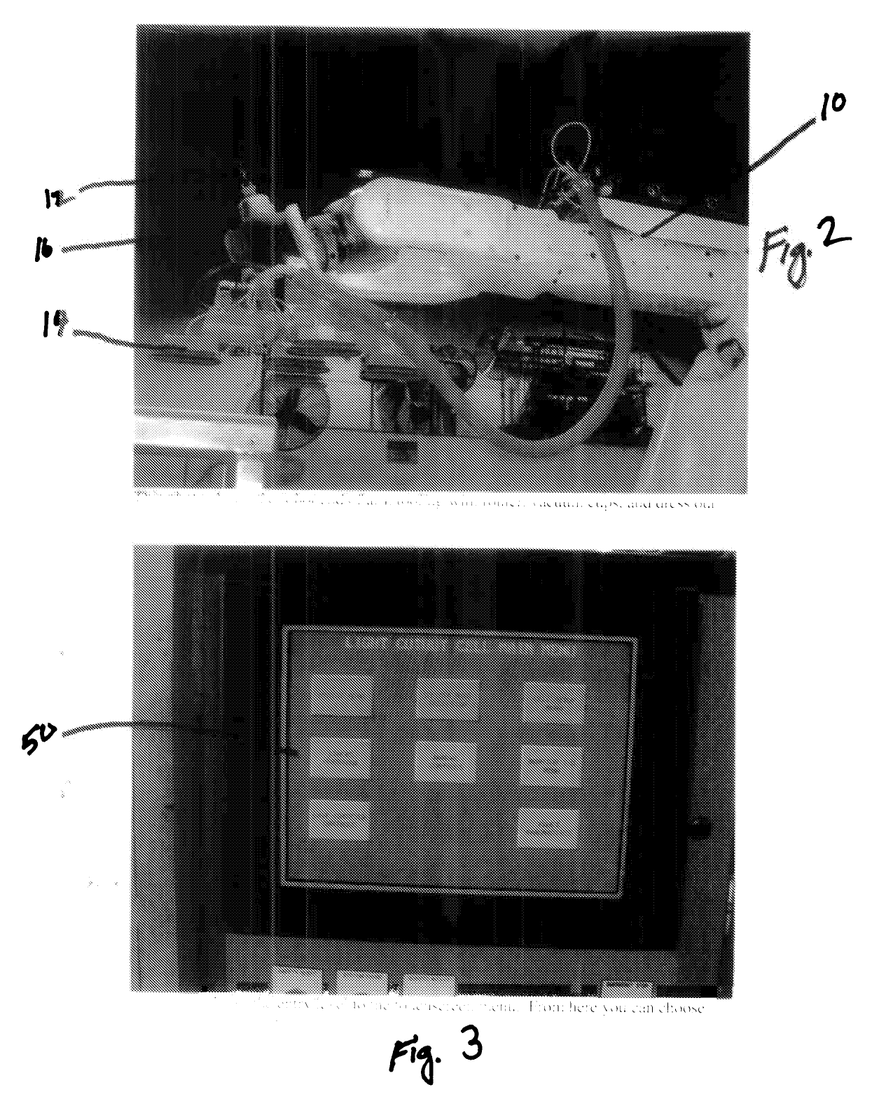

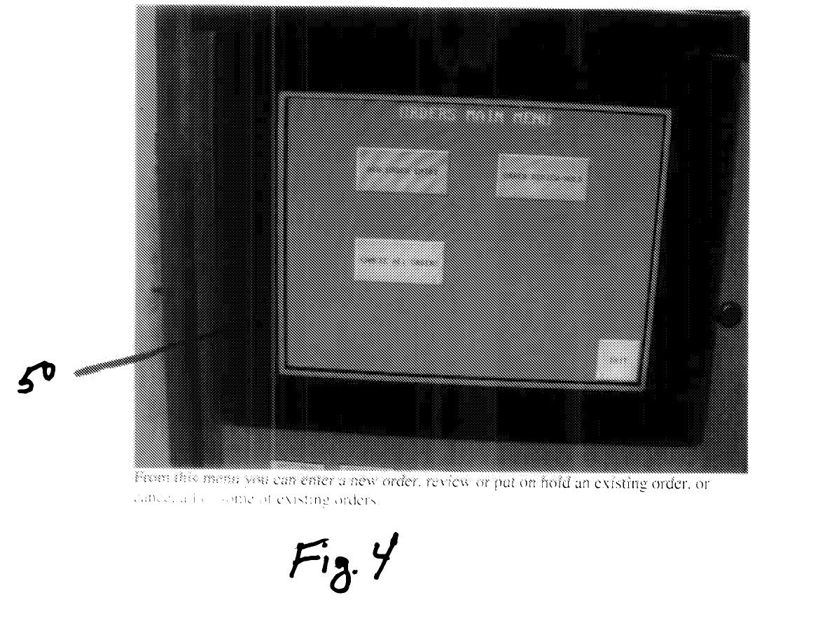

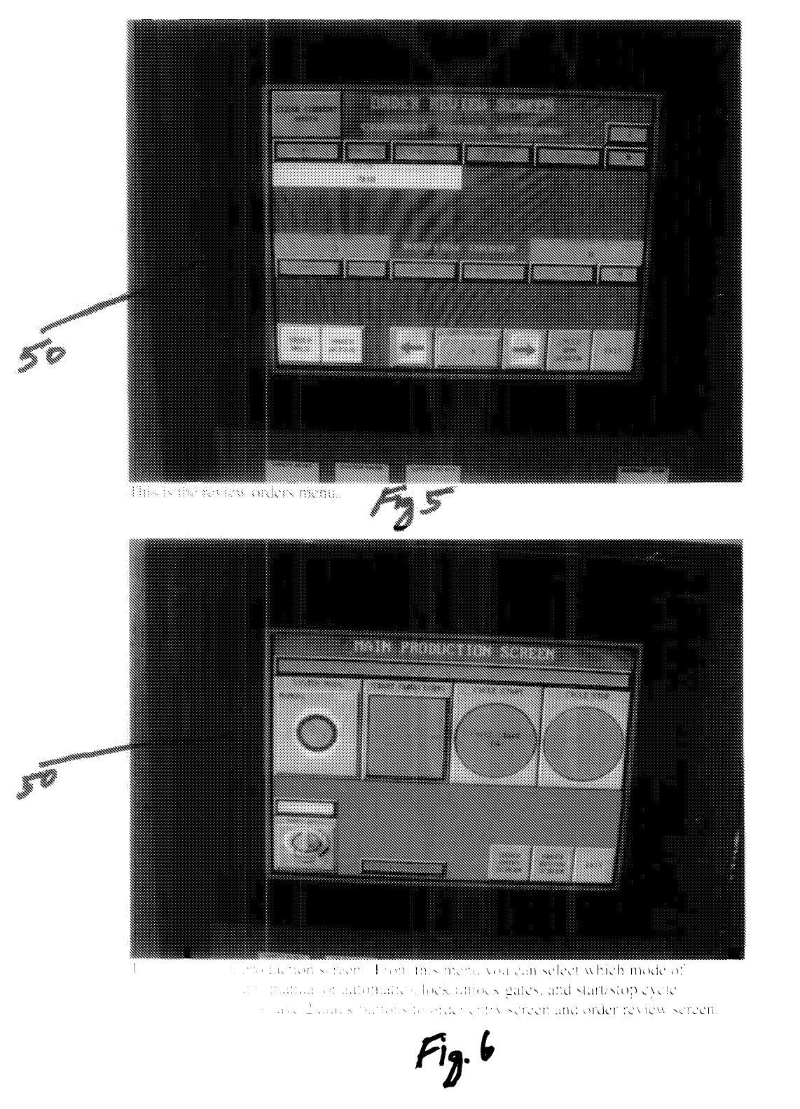

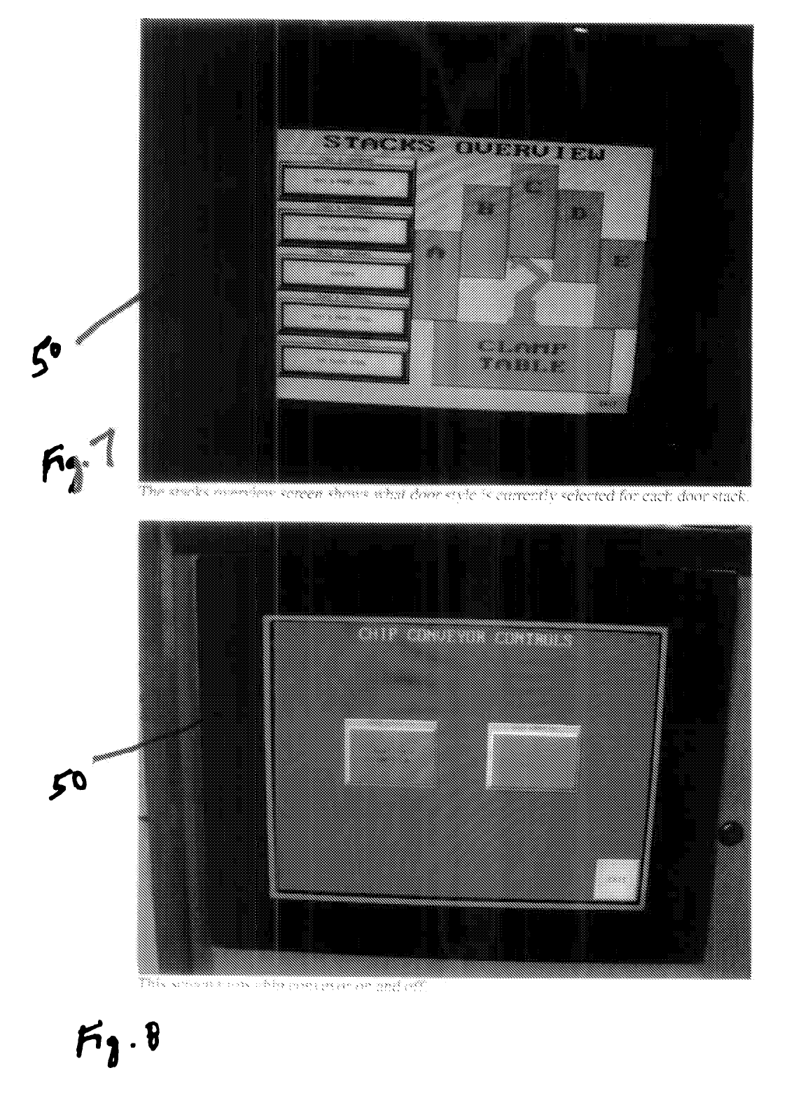

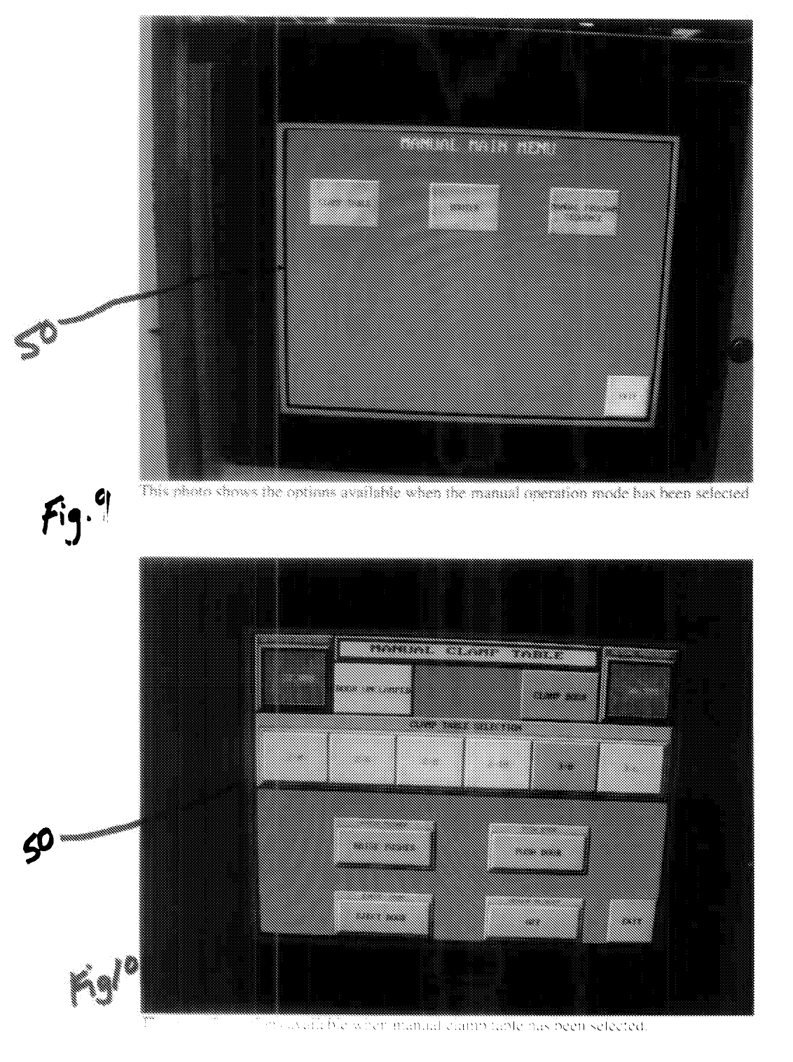

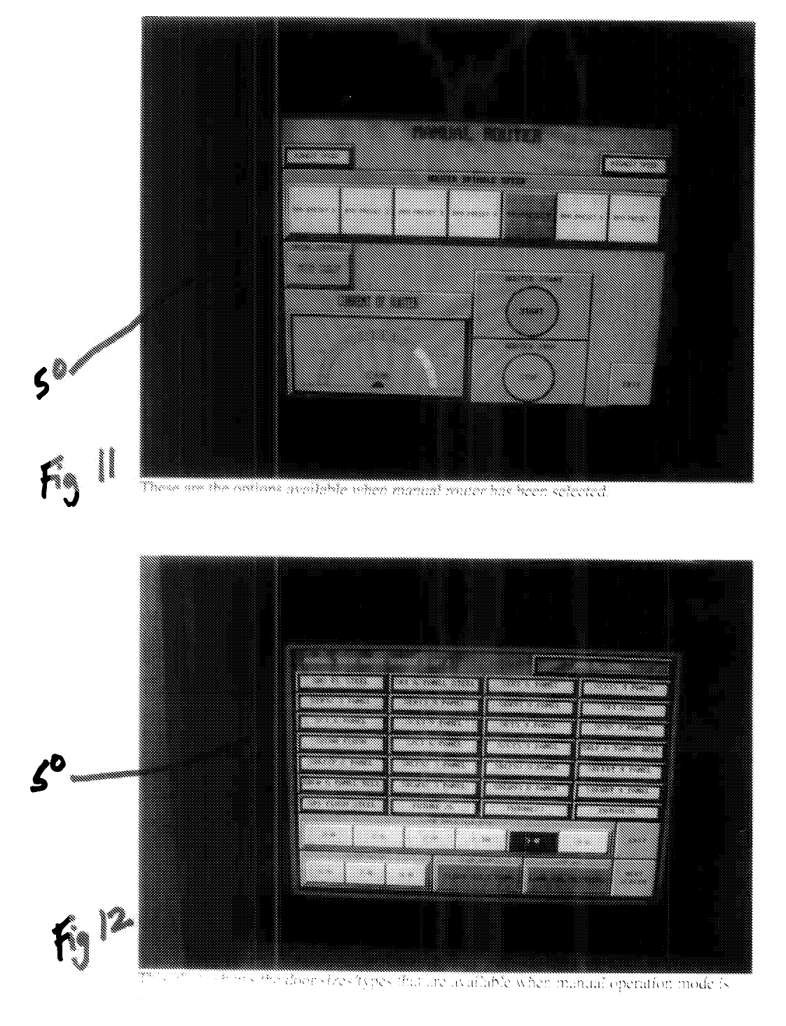

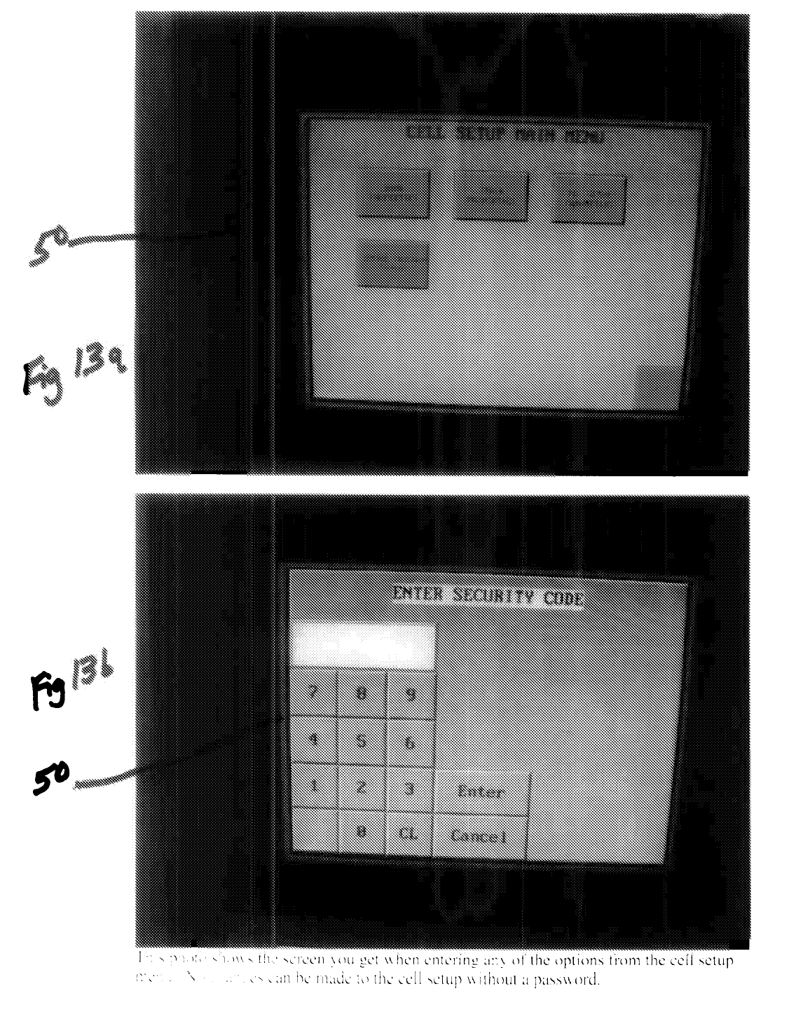

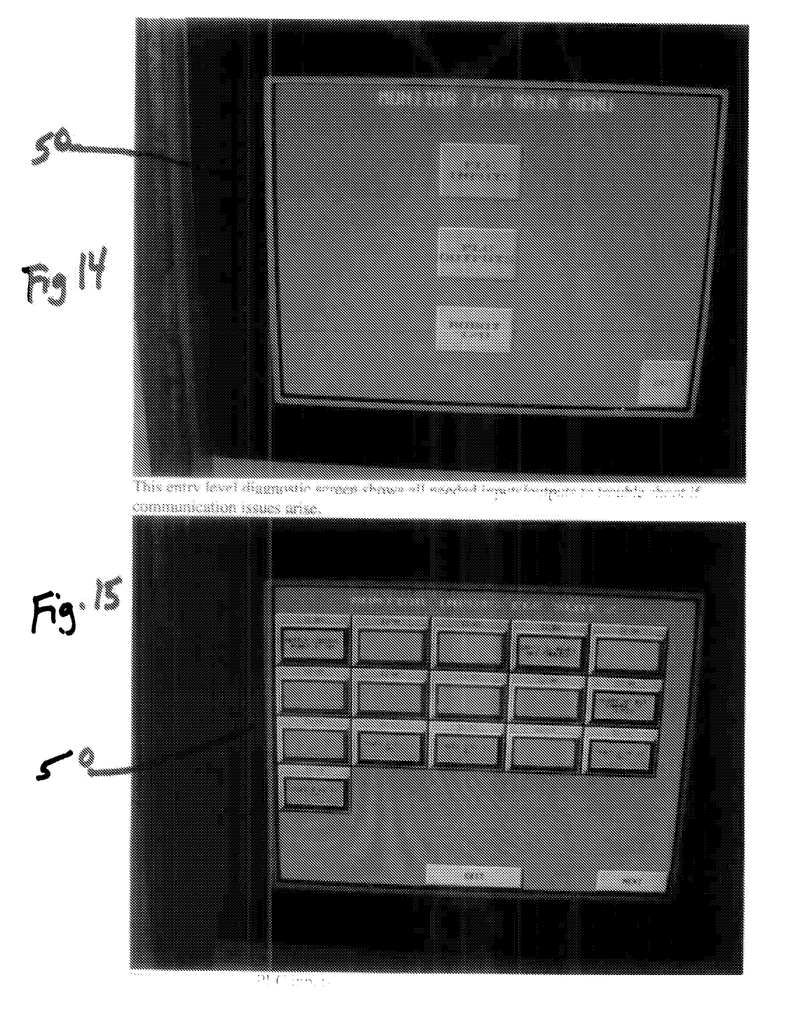

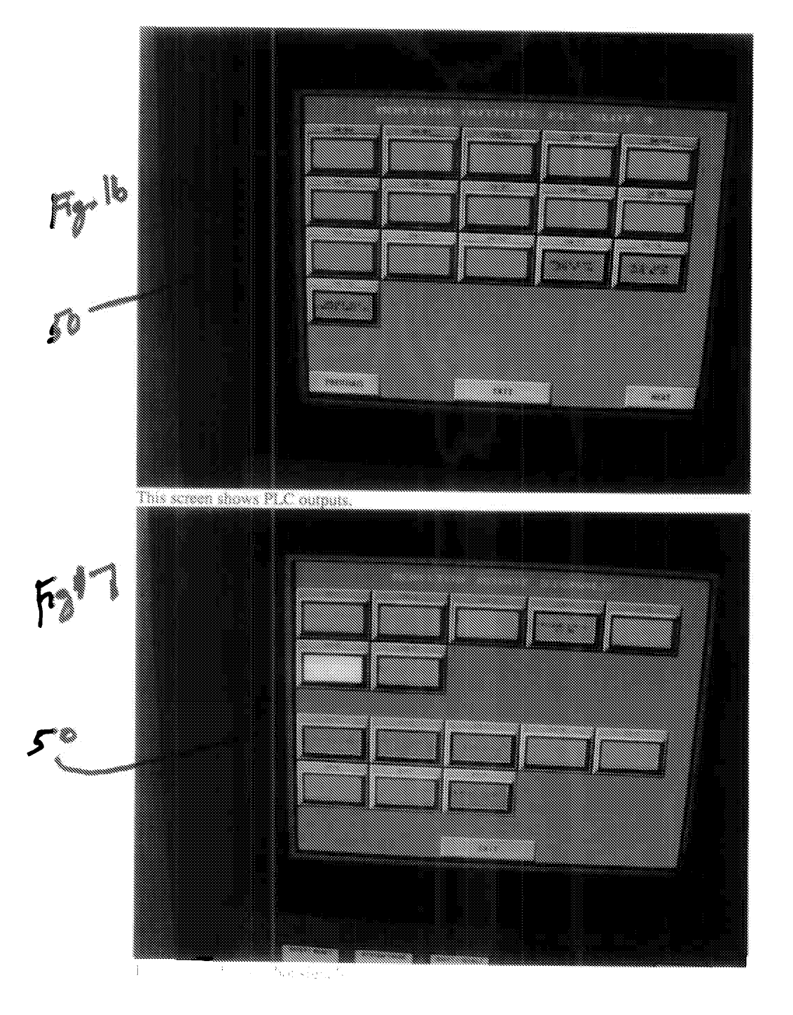

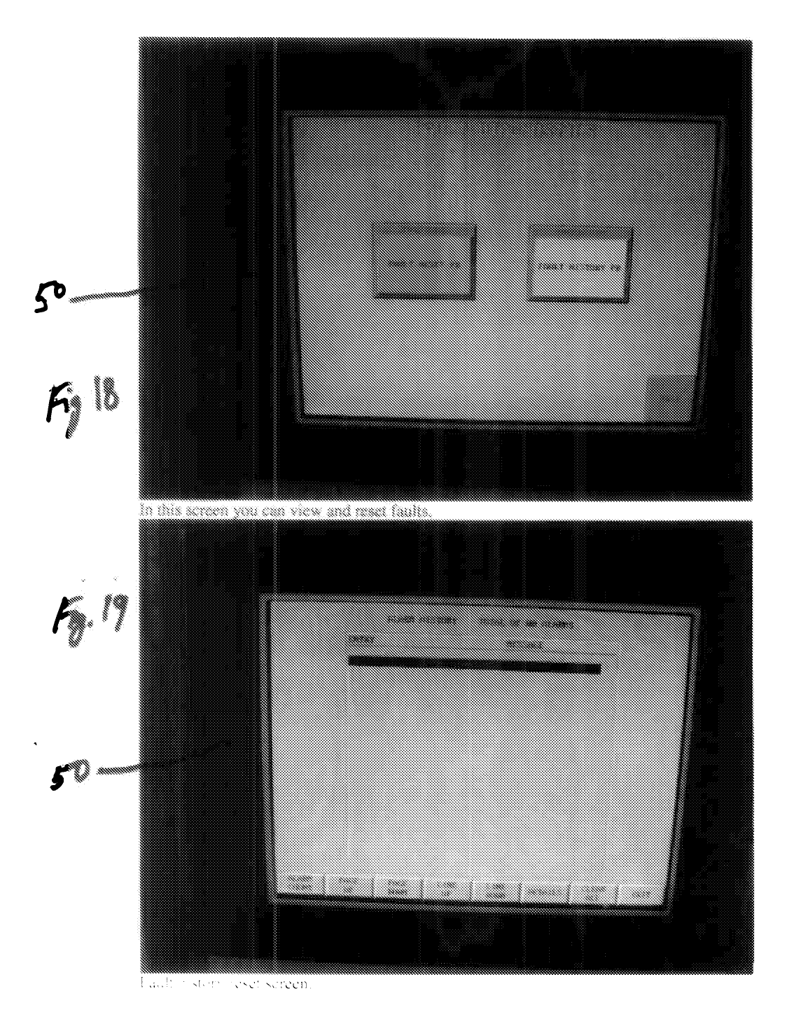

What is claimed is:

1. A device for manufacturing doors comprising:
a robotic arm that includes tooling for grasping and cutting a door;
a door stack including at least one door to be grasped and cut by the robotic arm; and
a router station for positioning of said door while being cut by said cutting tooling of said robotic arm.

2. The device as claimed in claim 1 further comprising a conveyor for removing cutouts made from said door.

3. The device as claimed in claim 1 wherein said door stack comprises a plurality of stacks.

4. The device as claimed in claim 1 wherein said door stack is positioned on a cart.

5. The device as claimed in claim 1 wherein said router station includes a clamp for clamping said door to said router station.

6. The device as claimed in claim 1 wherein said cutting tooling comprises a router.

7. The device as claimed in claim 1 wherein said grasping tooling comprises a vacuum pickup mechanism.

8. The device as claimed in claim 1 further comprising a touch-screen controller for controlling operation of said device.

9. The device as claimed in claim 1 further comprising a cage surround said robot, said door stack and said router station.

10. A method of manufacturing a door, said method comprising the steps of:
grasping a door from a door stack by a robot;
moving said grasped door from the door stack to a router table by the robot;
releasing said grasped door;
cutting said released door with tooling on said robot; and
grasping said cut door by said robot and moving said cut door to a finished location.

11. The method as claimed in claim 11 further comprising the steps of:
clamping said released door to the router table prior to said cutting step; and
unclamping said cut door after said cutting step.

12. The method as claimed in claim 11 further comprising the step of repeating the steps of claim 11 with another door upon placement of said cut door at said finished location.
